(19) United States
(12) Patent Application Publication
(10) Pub. No.: US 2025/0370789 A1
(43) Pub. Date: Dec. 4, 2025

(54) MULTI-GRAPH SCHEDULING FOR EFFICIENT USE OF NEURAL SIGNAL PROCESSOR RESOURCES

(71) Applicant: QUALCOMM Incorporated, San Diego, CA (US)

(72) Inventors: Brian KAHNE, Austin, TX (US); Chao CHEN, Farmers Branch, TX (US)

(21) Appl. No.: 18/677,453

(22) Filed: May 29, 2024

(51) Int. Cl. G06F 9/48

(52) U.S. Cl. CPC G06F 9/4818

(57) ABSTRACT

Certain aspects of the present disclosure provide techniques and apparatus for multi-graph execution in a processing system. Embodiments include receiving, by the processing system, a first graph representing operations related to a first machine learning model and a second graph representing operations related to a second machine learning model. Embodiments include prioritizing, by a first shared thread of the processing system, execution-ready operations from the first graph over execution-ready operations from the second graph. Embodiments include prioritizing, by a second shared thread of the processing system, execution-ready operations from the second graph over execution-ready operations from the first graph. Embodiments include executing, by the first shared thread and the second shared thread, respective operations related to the first machine learning model and the second machine learning model based on the prioritizing by the first shared thread and the prioritizing by the second shared thread.

### INTRODUCTION

Aspects of the present disclosure relate to scheduling of operations from multiple graphs in a processing system.

Operations of a machine learning model may be represented as a graph, such as a directed acyclic graph (DAG), that includes operations and dependencies between the operations. In some embodiments, a compiler may generate a compiled graph (e.g., DAG) that further breaks such operations into smaller, more granular, operations. A DAG is a graph that has forward progress, without loopbacks, among its nodes (e.g., a tree structure progressing from the trunk to the leaves). The graph may comprise a plurality of operations represented by graph nodes, and directed edges of the graph may indicate that certain operations are to be performed before other operations.

Threads of a processing device such as a neural signal processor (NSP) may execute operations from graphs in order to execute machine learning models, such as for using a machine learning model to generate an inference. Existing techniques for executing multiple graphs by threads of a processing device involve sequential execution of graphs (e.g., in order of priority or based on some other condition), with the processing device completing execution of a first graph before beginning execution of a second graph. However, such techniques are often inefficient and frequently result in under-utilization of available processing resources, leading to longer overall execution time for all machine learning tasks.

For example, a graph may transition from phases in which one type of processing thread (e.g., vector processing thread(s)) is used more extensively to phases in which a different type of processing thread (e.g., matrix processing thread(s)) is used more extensively, and during such phases the types of processing threads that are used less extensively may be significantly underutilized. Thus, existing techniques for graph execution on processing devices do not make use of all available processing resources, resulting in poor performance for execution of multiple graphs in many cases.

### BRIEF SUMMARY

Certain aspects provide a method, comprising: receiving, by the processing system, a first graph representing operations related to a first machine learning model and a second graph representing operations related to a second machine learning model; prioritizing, by a first shared thread of the processing system, execution-ready operations from the first graph over execution-ready operations from the second graph; prioritizing, by a second shared thread of the processing system, execution-ready operations from the second graph over execution-ready operations from the first graph; and executing, by the first shared thread and the second shared thread, respective operations related to the first machine learning model and the second machine learning model based on the prioritizing by the first shared thread and the prioritizing by the second shared thread.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 illustrates an example computing environment for multi-graph scheduling in a processing system according to various aspects of the present disclosure.

FIG. 2 illustrates an example of multi-graph scheduling in a processing system according to various aspects of the present disclosure.

FIG. 3 illustrates an example workflow for multi-graph scheduling in a processing system according to various aspects of the present disclosure.

FIG. 4 is a flow diagram depicting example results related to multi-graph scheduling in a processing system according to various aspects of the present disclosure.

FIG. 5 is a flow diagram depicting an example method of multi-graph scheduling in a processing system according to various aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for multi-graph scheduling in a processing system.

Existing techniques for executing multiple graphs (e.g., comprising machine learning model operations) involve sequential execution of the graphs, where one graph is completely executed before execution of another graph begins. In such techniques, processing resources are often significantly underutilized (e.g., during phases where one or more types of processing threads are not being used by the graph currently being executed), resulting in unnecessarily slow execution time across multiple graphs.

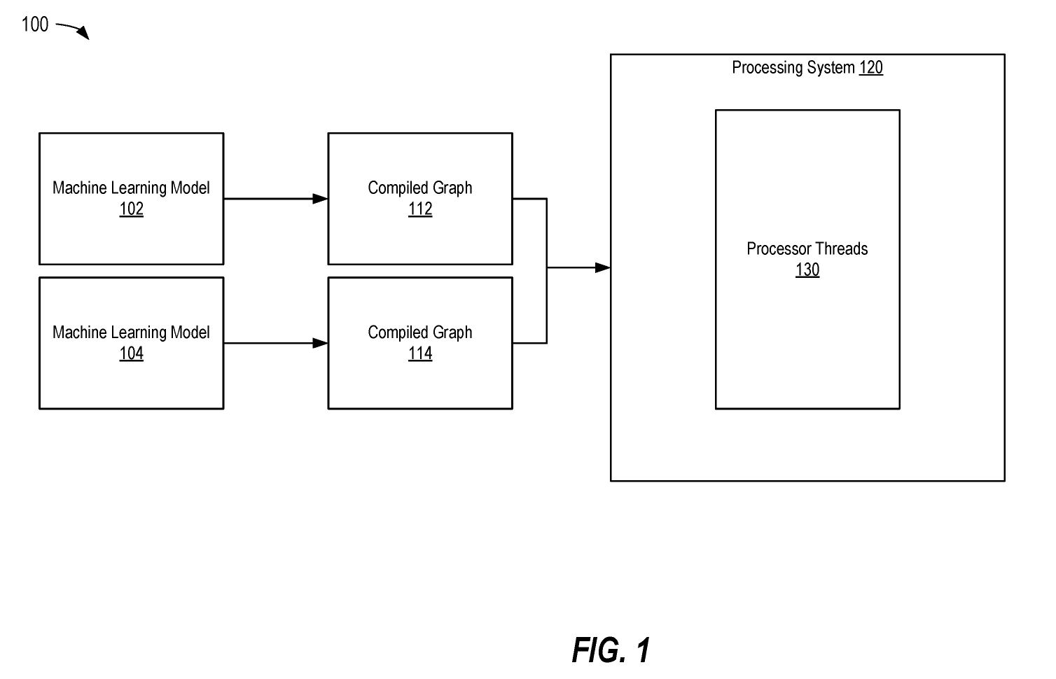

Techniques described herein overcome these problems by making use of the granular nature of operations within graphs to execute two graphs simultaneously at an operation level on threads of a processing device. Execution of graphs representing machine learning model operations via threads of a processing system is described in more detail below with respect to FIG. 1. For example, a machine learning model may be represented via a graph with nodes that represent operations and edges (e.g., directed edges) representing dependencies among the operations (e.g., indicating which operations are to be executed before other operations). The graph may be a “compiled” graph that has been generated through the use of a compiler that “tiles” (e.g., subdivides) operations in order to generate a micro-tiled (e.g., sub-divided into a larger number of operations that are subcomponents of the operations in an initial graph) directed acyclic graph (DAG) with granular operations that can be individually executed. In order to simultaneously execute multiple graphs, one or more threads of a processing device may be shared among the multiple graphs rather than being associated exclusively with one graph.

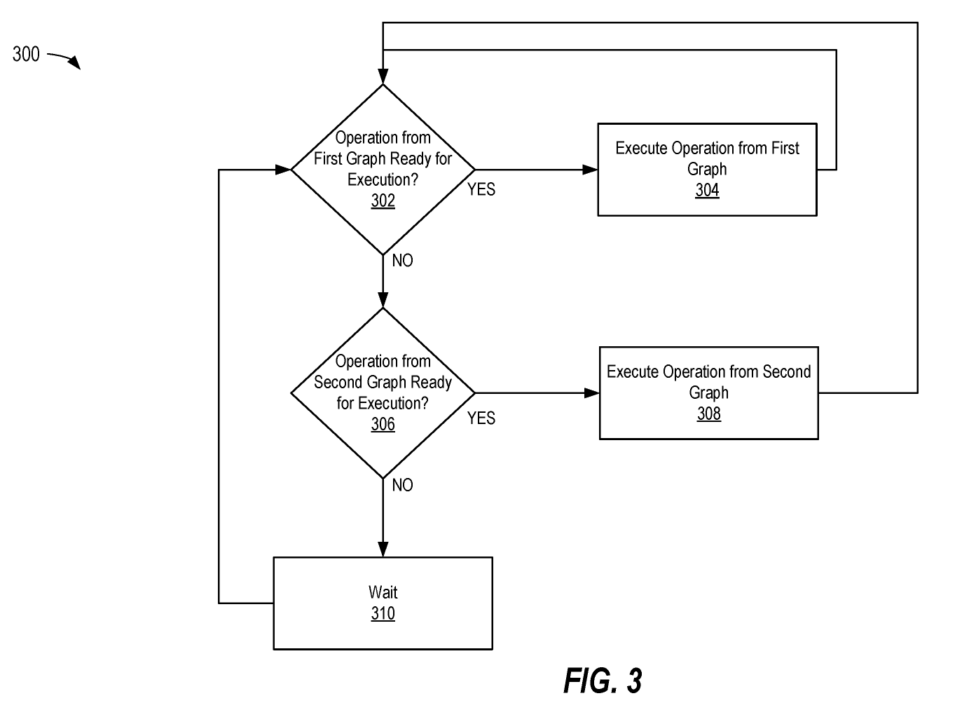

For example, a processing thread may prioritize one graph, but may execute operations from a different graph if there is no operation from the prioritized graph ready for execution. Thus, rather than remaining idle when not being utilized for execution of a first graph, such a processing thread may execute one or more operations from a second graph so that both graphs continue to make progress. In some embodiments, a processing device includes multiple such shared processing threads, each of which is configured to sequentially execute a next available operation from a prioritized graph or, if no such operation is ready for execution, to execute a next available operation from a different graph. An example graph prioritization scheme for executing operations of multiple graphs by a shared processing thread is described in more detail below with respect to FIG. 3.

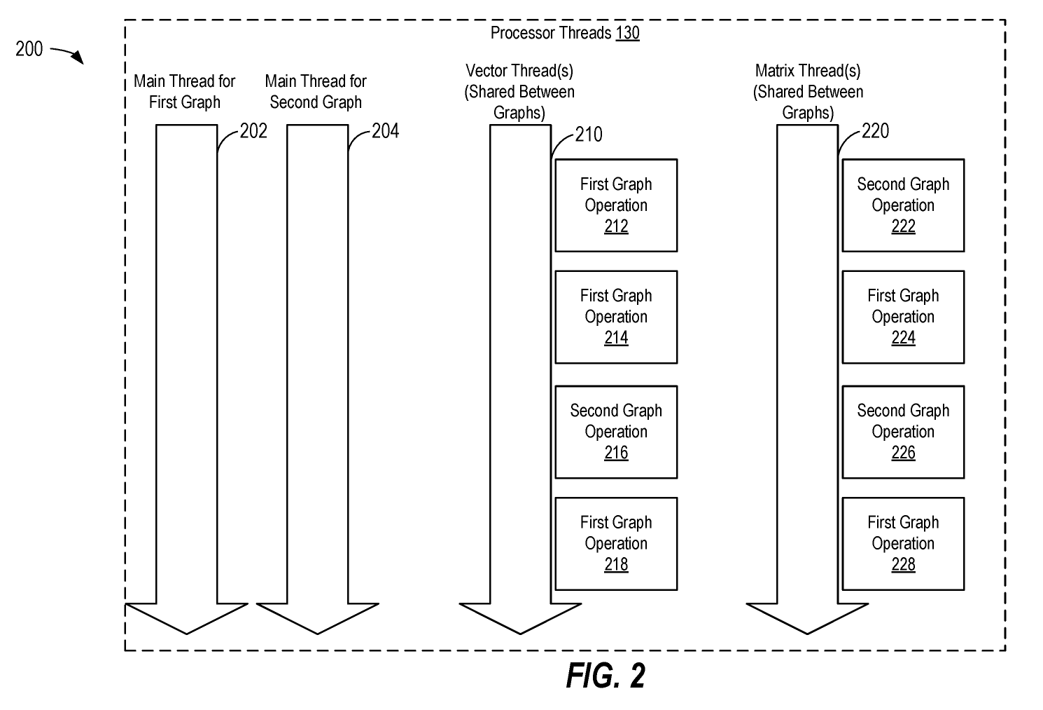

Furthermore, aspects of the present disclosure involve varying priorities of graphs within the processing device to further reduce overall execution time across multiple graphs. In some embodiments, varying of priorities is achieved by configuring different shared processing threads to prioritize different graphs. For example, a first shared processor thread may prioritize a first graph while a second shared processor thread may prioritize a second graph. Thus, both the first graph and the second graph may make similar amounts of progress over time, and the total execution time for the two graphs may be shortened. An example distribution of operations across different threads of such a processing system for simultaneous execution of multiple graphs is described in more detail below with respect to FIG. 2.

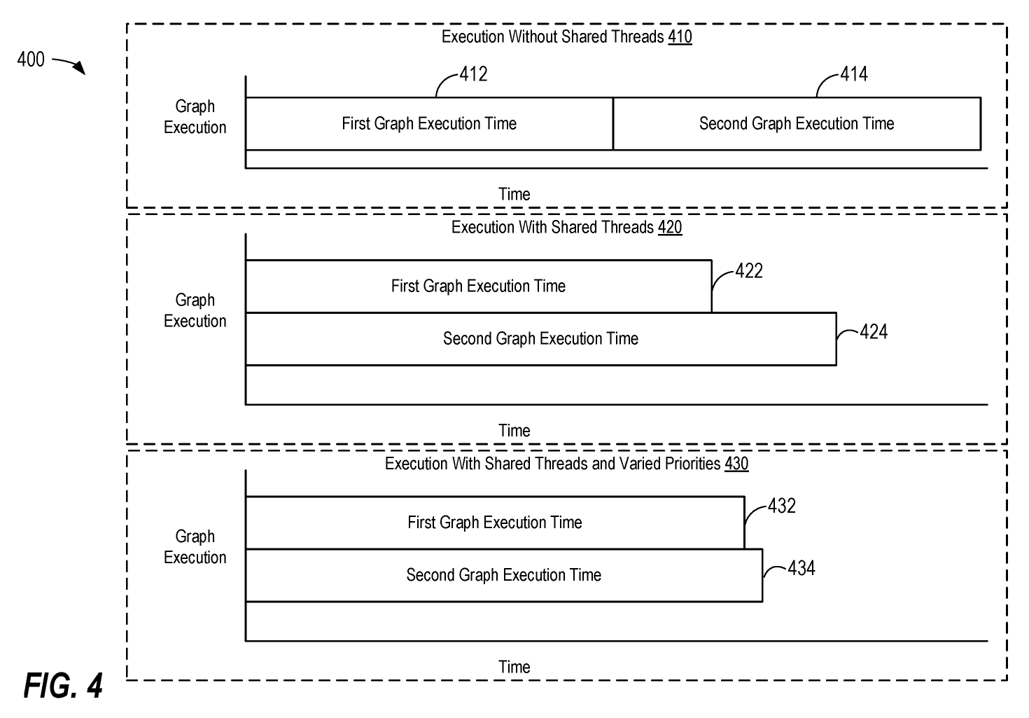

As described in more detail below with respect to FIG. 4, techniques described herein improve overall utilization of available processing resources of a processing system, and thereby reduce the overall execution time across multiple graphs. For example, by sharing processing threads across multiple graphs such that each shared processing thread executes available operations from a different graph if no operations from a first (e.g., prioritized) graph are available to execute, techniques described herein allow such threads to be utilized despite the unavailability of an operation to execute from the first graph. Furthermore, by varying priorities of graphs in a processing system, such as by configuring different shared processing threads to prioritize different graphs, aspects of the present disclosure further reduce the disparity between completion times of multiple graphs and/or further reduce the overall execution time of the multiple graphs.

Thus, techniques described herein improve the functioning of computing devices by improving processing resource utilization and processor throughput for multi-graph execution. Furthermore, aspects of the present disclosure improve the technical field of graph-based machine learning model execution by reducing the overall execution time of multiple graphs in a processing system through the use of shared processing threads and/or varied graph priorities as described herein.

### Example Computing Environment for Multi-Graph Scheduling in a Processing System

FIG. 1 illustrates an example computing environment 100 for multi-graph scheduling in a processing system according to various aspects of the present disclosure. Computing environment 100 includes a processing system 120, which generally represents a physical computing device comprising one or more processors, such as a central processing unit (CPU) and/or a neural signal processor (NSP).

Processing system 120 includes processing threads 130, each of which represents a software thread that corresponds to a hardware thread of a processor. Processor threads 130 may include threads that correspond to particular processing components such as a vector coprocessor, a matrix coprocessor, and/or the like. For example, processing system 120 may include a vector coprocessor that performs vector computations and a matrix coprocessor that performs matrix computations, and each may have one or more processing threads. Such a vector coprocessor and/or matrix coprocessor may be particularly useful for processing applications that require fast and parallel execution, such as machine learning, multimedia, video streaming, and/or the like. In an aspect, a vector coprocessor and/or matrix coprocessor may implement a single instruction multiple data (SIMD) instruction set architecture (ISA) that includes independent hardware registers, memory, and/or execution hardware. Such a coprocessor may be a part of, or closely coupled to, a main processor (e.g., CPU) of processing system 120.

Each of machine learning models 102 and 104 may represent any type of machine learning model, such as a neural network. Neural networks, which may be referred to as Artificial Neural Networks (ANNs), are used to perform an increasing number and variety of tasks, such as, for example, object recognition, speech recognition, speech generation, providing recommendations, and predicting user behavior. Performing these tasks may be referred to as inferencing using a neural network. To provide useful inferences, a neural network needs to be designed and trained for the particular task. The neural network design establishes parameters such as the number of layers of the neural network model and the characteristics of each layer. The training of the neural network generally uses training data, inferencing using the neural network, feedback based on evaluation of the inference, and backpropagation to adjust the weights of the neural network model in response to the feedback. After numerous training cycles of inferencing and backpropagation, the resultant model may provide satisfactory results in response to new input data. Note that many neural networks have multiple hidden layers between an input layer and an output layer and may consequently be referred to as Deep Neural Networks (DNNs). In some cases, operations of a machine learning model such as a neural network may be represented as a graph with nodes representing operations and edges representing dependencies among the operations. Further, a compiler may be used to generate a compiled graph in which the operations of the machine learning model are further divided into “micro-tiled” operations that are more granular.

Compiled graphs 112 and 114 representing machine learning models 102 and 104, respectively, may be generated. For example, a machine learning model description of each of machine learning models 102 and 104 may be provided to a compiler, which may transform each machine learning model description into a form that may be represented by a graph such as a directed acyclic graph (DAG). The graph comprises a plurality of operations represented by graph nodes and dependencies represented by graph edges. Such a graph may show which operations are to be completed before certain other operations. Furthermore, the compiler may convert the operations in the graphs into more granular operations (e.g., command lists) in order to create compiled graphs 112 and 114. For example, each node in compiled graphs 112 and 114 may represent an individual scalar, vector, matrix, or data movement operation, or the like, and directed edges between the nodes may represent the dependencies among such operations.

According to techniques described herein, compiled graphs 112 and 114 may be scheduled for simultaneous execution via processor threads 130 of processing system 120. For example, as described in more detail below with respect to FIG. 2, each of compiled graphs 112 and 114 may be assigned a dedicated thread from processor threads 130, while one or more other threads of processor threads 130 may be shared between compiled graphs 112 and 114. In one example, one or more vector processing threads and/or matrix processing threads of processor threads 130 may be configured to prioritize a first one of compiled graphs 112 and 114, but to execute a next available operation from the other one of compiled graphs 112 and 114 if there is no available operation from the first one of compiled graphs 112 and 114 to execute. An available operation or execution-ready operation refers to an operation from a graph that is ready to be executed, such as when any operation(s) on which the operation depends have been completed.

In some cases, priorities of compiled graphs 112 and 114 may be varied within processor system 120 so that both compiled graphs 112 and 114 are able to make relatively consistent forward progress. In a particular example, a first thread of processor threads 130 prioritizes compiled graph 112 and a second processor thread of processor threads 130 prioritizes compiled graph 114. For example, the first thread may (e.g., sequentially) attempt to execute an operation from compiled graph 112 and, if such an operation is ready to be executed, proceed with executing the operation. Otherwise, if no operation from compiled graph 112 is ready to be executed, the first thread may determine whether there is an execution-ready operation from compiled graph 114 and, if so, may execute such an operation from compiled graph 114. If there is no execution-ready operation from either compiled graph 112 or 114 (or any other graph that is being simultaneously executed), then the first thread may wait (e.g., for some amount of time or until an operation is ready to execute) and then may again attempt to execute an operation from compiled graph 112 (e.g., repeating the sequential process). Similarly, the second thread may (e.g., sequentially) attempt to execute an operation from compiled graph 114 and, if such an operation is ready to be executed, proceed with executing the operation. Otherwise, if no operation from compiled graph 114 is ready to be executed, the second thread may determine whether there is an execution-ready operation from compiled graph 112 and, if so, may execute such an operation from compiled graph 112. If there is no execution-ready operation from either compiled graph 114 or 112 (or any other graph that is being simultaneously executed), then the second thread may wait (e.g., for some amount of time or until an operation is ready to execute) and then may again attempt to execute an operation from compiled graph 114 (e.g., repeating the sequential process). An example of such an algorithm is described in more detail below with respect to FIG. 3.

Thus, compiled graphs 112 and 114 may be simultaneously executed via processor threads 130 in such a manner that available processing resources are consistently utilized and an improved overall execution time for compiled graphs 112 and 114 is achieved. It is noted that techniques described herein may be used to simultaneously execute more than two graphs, such as with priorities of the two or more graphs being varied among processor threads 130. Furthermore, processor threads 130 may include multiple shared threads that prioritize each of a plurality of graphs that are simultaneously executed (e.g., one or multiple shared threads may prioritize each graph).

It is noted that while certain embodiments described herein involve graphs that represent operations of machine learning models, other embodiments of the present disclosure may involve graphs that represent other types of operations. For example, techniques described herein may be used with any graph that includes dependencies between operations in the graph, such as for two or more graphs that include dependencies among operations within the same graph but for which there are no dependencies between the different graphs and where the two or more graphs are able to share computing resources.

### Example Processor Threads for Multi-Graph Scheduling

FIG. 2 is a diagram 200 illustrating an example of processor threads for multi-graph scheduling according to various aspects of the present disclosure. Diagram 200 includes processor threads 130 of FIG. 1 and represents an example of such processor threads.

In diagram 200, processor threads 130 include a main thread 202 for a first graph (e.g., the first graph may be compiled graph 112 of FIG. 1) and a main thread 204 for a second graph (e.g., the second graph may be compiled graph 114 of FIG. 1). Main thread 202 may be dedicated to the first graph and main thread 204 may be dedicated to the second thread. For example, each of main threads 202 and 204 may perform operations such as data movement, sequencing, and the like for a particular graph.

Processor threads 130 in diagram 200 further include one or more vector threads 210, which are shared between the first graph and the second graph. Vector thread(s) 210 may be worker threads of a vector coprocessor. In one particular example, there are two vector threads 210 (e.g., of a vector coprocessor), both of which are shared between the first graph and the second graph, and a single matrix thread 220 (e.g., of a matrix coprocessor), which is shared between the first graph and the second graph. In some embodiments, priorities of the first graph and the second graph are varied among vector threads 210. For example, one of vector threads 210 may prioritize the first graph while another one of vector threads 210 may prioritize the second graph. As described in more detail below with respect to FIG. 3, each of vector threads 210 may sequentially attempt to execute an available operation from a prioritized graph and, if no such operation is ready to execute, may attempt to execute an available operation from a different (e.g., non-prioritized or lower priority) graph. Generally, each of vector threads 210 may greedily attempt to execute the next available operation from the highest priority graph that has an operation ready to execute, such as in an iterative loop.

Processor threads 130 in diagram 200 further include one or more matrix threads 220, which are shared between the first graph and the second graph. Matrix thread(s) 220 may be worker threads of a matrix coprocessor. In one particular example, there is one matrix thread 220, which is shared between the first graph and the second graph. For example, the one matrix thread 220 may prioritize one of the graphs (e.g., the second graph). In alternative embodiments there are two or more matrix threads 220, and priorities of the first graph and the second graph are varied among matrix threads 220. For example, one of matrix threads 220 may prioritize the first graph while another one of matrix threads 220 may prioritize the second graph. As described in more detail below with respect to FIG. 3, each of the one or more matrix threads 220 may sequentially attempt to execute an available operation from a prioritized graph and, if no such operation is ready to execute, may attempt to execute an available operation from a different (e.g., non-prioritized or lower priority) graph. Generally, each of the one or more matrix threads 220 may greedily attempt to execute the next available operation from the highest priority graph that has an operation ready to execute, such as in an iterative loop.

Graph priorities may be thread-specific. For example, a graph that is prioritized by one thread may not be prioritized by another thread. In some embodiments, such as when more than two graphs are simultaneously executed, a given thread may prioritize the graphs in a particular order, such as assigning a first (e.g., highest) priority to a first graph, a second (e.g., medium) priority to a second graph, and a third (e.g., lowest) priority to a third graph.

In the example depicted in diagram 200, a given vector thread 210 executes a first graph operation 212, then another first graph operation 214, then a second graph operation 216, and then another first graph operation 218. For example, the vector thread 210 may prioritize the first graph, and may execute first graph operations 212 and 214 and then, upon determining there are no first graph operations ready to execute, may execute second graph operation 216 (e.g., upon determining that there is a second graph operation ready to execute). Then, the vector thread 210 may determine that there is another first graph operation ready to execute, and so may execute first graph operation 218.

In the example depicted in diagram 200, a given matrix thread 220 executes a second graph operation 222, then a first graph operation 224, then another second graph operation 226, and then another first graph operation 228. For example, the matrix thread 220 may prioritize the second graph, and may execute second graph operation 222 and then, upon determining there are no second graph operations ready to execute, may execute first graph operation 224 (e.g., upon determining that there is a first graph operation ready to execute). Then, the matrix thread 220 may determine that there is another second graph operation ready to execute, and so may execute second graph operation 226. Subsequently, upon determining there are no second graph operations ready to execute, matrix thread 220 may execute first graph operation 228 (e.g., upon determining that there is a first graph operation ready to execute). Thus, both the first graph and the second graph continue to make progress, and available processing resources are effectively utilized.

### Example Graph Execution Workflow for a Shared Thread

FIG. 3 illustrates an example workflow 300 for multi-graph scheduling in a processing system according to various aspects of the present disclosure. For example, workflow 300 may represent logic implemented via a processor thread 130 of FIGS. 1 and 2.

In workflow 300, the thread first determines at decision 302 if there is an operation from a first graph (e.g., compiled graph 112 of FIG. 1) ready for execution. For example, the thread may prioritize the first graph. If there is an execution-ready operation from the first graph, then the workflow proceeds to block 304, where the thread executes the execution-ready operation from the first graph.

If there is no execution-ready operation from the first graph, then the workflow proceeds to decision 306, where the thread determines if there is an operation from a second graph (e.g., compiled graph 114 of FIG. 1) ready for execution. If there is an execution-ready operation from the second graph, then the workflow proceeds to block 308, where the thread executes the execution-ready operation from the second graph.

If there is no execution-ready operation from the second graph, then the workflow proceeds to block 310, where the thread waits, such as for a given amount of time, until some condition occurs (e.g., availability of an execution-ready operation), and/or the thread may immediately return to decision 302 (e.g., without any delay after determining that there is no execution-ready operation from the second graph). In some embodiments, block 310 signifies that the thread does not execute an operation until an execution-ready operation is available from one of the graphs.

After completing an iteration of workflow 300 (e.g., after an operation from the first graph is executed at block 304, an operation from the second graph is executed at block 308, or the thread reaches block 310 when there is no execution-ready operation), another iteration of workflow 300 begins at decision 302, where the thread again determines if there is an operation from the first graph ready for execution. Workflow 300 may then proceed as described above (e.g., for multiple sequential iterations).

While workflow 300 includes an example with two graphs, other embodiments may involve simultaneous execution of three or more graphs, such as with different priorities being assigned to each graph, and/or with one graph being prioritized and the other graphs being non-prioritized.

### Example Multi-Graph Execution Time Improvements

FIG. 4 is a flow diagram 400 depicting example results related to multi-graph scheduling in a processing system according to various aspects of the present disclosure. Diagram 400 generally represents results of the multi-graph execution techniques described above, such as representing the relative execution times of a first graph (e.g., compiled graph 112 of FIG. 1) and a second graph (e.g., compiled graph 114 of FIG. 1) by processor threads 130 of FIG. 1 with different multi-graph execution schemes. Each example is depicted on a two-dimensional graph where the y axis represents a particular graph’s execution and the x axis represents time (e.g., which may be in any unit of time, such as milliseconds).

Example result of execution without shared threads 410 represents relative execution times of the first graph and the second graph using conventional techniques where graphs are sequentially executed such that one graph is completely executed before execution of another graph begins. As shown, first graph execution time 412 completes and then second graph execution time 414 begins. While first graph execution time 412 and second graph execution time 414 are relatively equal to one another, the second graph does not even begin to execute until the first graph is completely executed. Thus, the total execution time for the first graph and the second graph is relatively long in execution without shared threads 410, such as due to underutilization of available processing resources during both first graph execution time 412 and second graph execution time 414.

Example result of execution with shared threads 420 represents relative execution times of the first graph and the second graph using techniques described herein where the first graph and the second graph are simultaneously executed but where graph priorities are not varied, and the first graph is prioritized by all shared threads. As shown, first graph execution time 422 is shorter than second graph execution time 424 because the first graph is prioritized, but the second graph continues to make progress during first graph execution time 422 because of the shared threads that execute second graph operations when there are no execution-ready first graph operations. Thus, the total execution time of the first graph and the second graph is shorter in execution with shared threads 420 than in execution without shared threads 410. For example, second graph execution time 424 (representing the shared thread execution time of the second graph) ends significantly before second graph execution time 414 (representing the non-shared thread execution time for the second graph).

Example result of execution with shared threads and varied priorities 430 represents relative execution times of the first graph and the second graph using techniques described herein where the first graph and the second graph are simultaneously executed and where graph priorities are varied (e.g., by configuring different shared threads to prioritize different graphs). For example, one or more shared threads may prioritize the first graph while one or more other threads may prioritize the second graph. As shown, first graph execution time 432 and second graph execution time 434 complete around the same time. Thus, the use of varied priorities reduces the disparity in completion times for the first and second graph (e.g., compared to both execution without shared threads 410 and execution with shared threads 420), as both graphs are able to make similar amounts of progress over time due to each graph being prioritized by at least one of the threads as opposed to only one graph being prioritized by all threads. Furthermore, the total execution time of the first graph and the second graph is shorter in execution with shared threads and varied priorities 430 than in execution without shared threads 410 or execution with shared threads 420. In other examples, the total execution time of the first graph and the second graph may be relatively similar in execution with shared threads and varied priorities 430 and execution with shared threads 420, although the disparity in completion times may be reduced in execution with shared threads and varied priorities 430 compared with execution with shared threads 420.

It is noted that while certain examples are described in which graph priorities are varied across different threads, other embodiments may involve varying graph priorities within a single thread. For example, a given thread may prioritize a first graph on a first iteration and may then prioritize a second graph on a second iteration, such as alternating, cycling, and/or otherwise changing graph priorities across subsequent iterations.

Techniques described herein generally leverage the multi-threaded nature of processing systems such as NSPs to provide techniques for simultaneous execution of multiple graphs. Furthermore, given the “micro-tiled” nature of operations in compiled graphs, such operations may be effectively multiplexed across multiple processor threads in order to efficiently execute multiple graphs simultaneously. Embodiments of the present disclosure may be implemented via software without requiring specialized hardware, as techniques described herein may implemented with existing multi-threaded processors.

### Example Method for Multi-Graph Scheduling in a Processing System

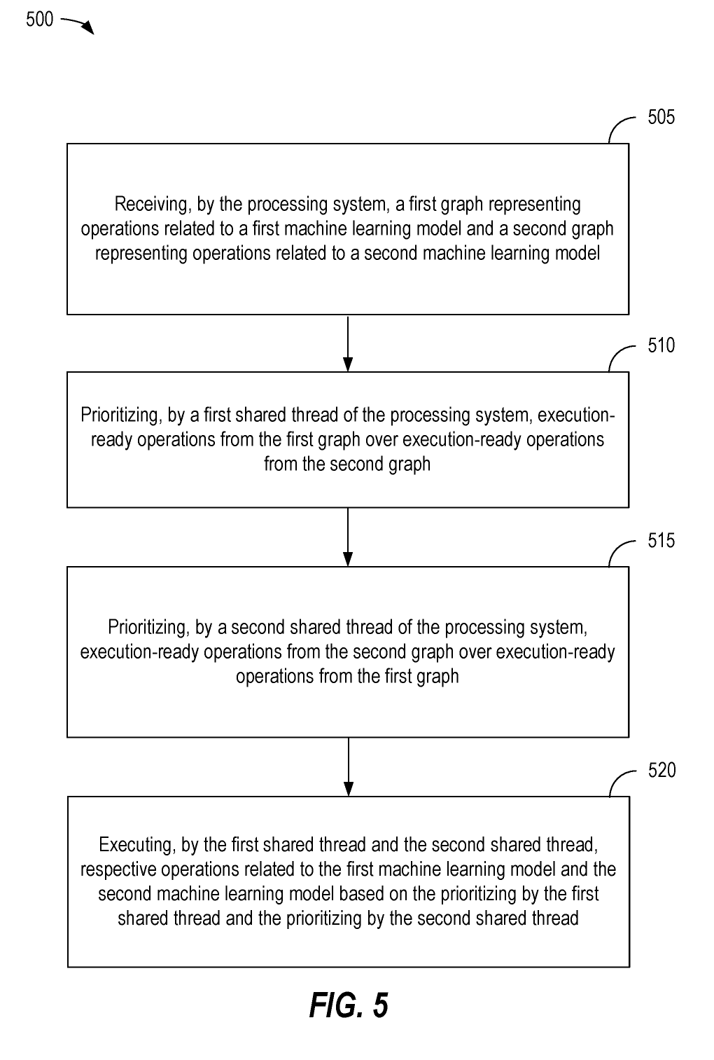

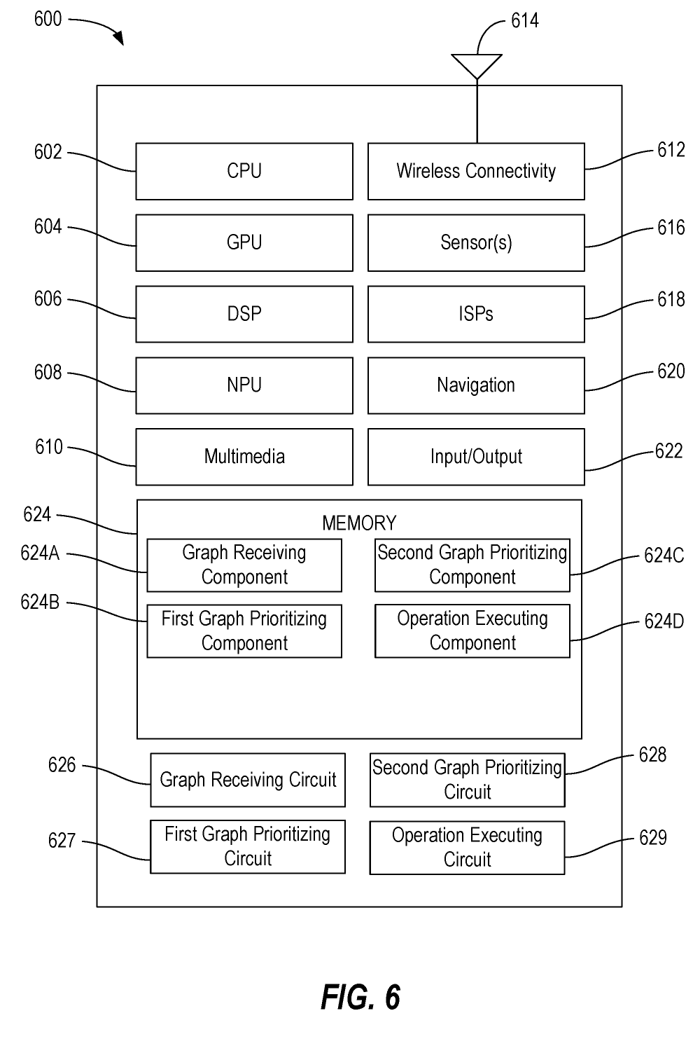

FIG. 5 is a diagram depicting an example method 500 for multi-graph execution in a processing system, according to various aspects of the present disclosure. For example, method 500 may be performed by one or more components of processing system 120 of FIG. 1 and/or by processing system 600 of FIG. 6, described below. Method 500 may relate to one or more of the simultaneous graph execution techniques described above with respect to FIGS. 1-4.

Method 500 begins at block 505, with receiving, by the processing system, a first graph representing operations related to a first machine learning model and a second graph representing operations related to a second machine learning model.

Method 500 continues at block 510, with prioritizing, by a first shared thread of the processing system, execution-ready operations from the first graph over execution-ready operations from the second graph. For example, the first shared thread may prioritize execution-ready operations from the first graph over execution-ready operations from the second graph by executing any execution-ready operation from the first graph before executing any execution-ready operation from the second graph, such as only executing an execution-ready operation from the second graph if there are no execution-ready operations from the first graph.

Method 500 continues at block 515, with prioritizing, by a second shared thread of the processing system, execution-ready operations from the second graph over execution-ready operations from the first graph. For example, the second shared thread may prioritize execution-ready operations from the second graph over execution-ready operations from the first graph by executing any execution-ready operation from the second graph before executing any execution-ready operation from the first graph, such as only executing an execution-ready operation from the first graph if there are no execution-ready operations from the second graph.

In some embodiments, priorities of graphs for threads are set by one or more separate components such as a scheduler that is responsible for scheduling tasks for the processing system, and a thread prioritizes one graph over another as a result of action by such a separate component.

Method 500 continues at block 520, with executing, by the first shared thread and the second shared thread, respective operations related to the first machine learning model and the second machine learning model based on the prioritizing by the first shared thread and the prioritizing by the second shared thread.

In some embodiments, the first shared thread is configured to execute an execution-ready operation from the second graph if there is no execution-ready operation from the first graph, and the second shared thread is configured to execute an execution-ready operation from the first graph if there is no execution-ready operation from the second graph.

In certain embodiments, the prioritizing by the first shared thread comprises determining whether there is an execution-ready operation from the second graph upon determining that there is no execution-ready operation from the first graph, wherein the first shared thread is configured to wait for a given condition to occur if there is no execution-ready operation from the second graph.

In some embodiments, the given condition relates to expiry of a time period or availability of a given execution-ready operation, and wherein, when the given condition occurs, the first shared thread is configured to again prioritize execution-ready operations from the first graph over execution-ready operations from the second graph.

Certain embodiments further comprise determining, by the first shared thread, whether there is an execution-ready operation from the first graph based on one or more dependencies in the first graph. For example, the first thread may determine that a given operation from the first graph is an execution-ready operation if any operation(s) on which the given operation depends in the first graph have been completed. Generally, a thread may determine that a given operation in a given graph is execution-ready if any operation(s) on which the given operation depends in the given graph have been completed.

In some embodiments, the first shared thread and the second shared thread correspond to respective processor threads of a vector coprocessor of the processing system.

Certain embodiments further comprise prioritizing, by a third shared thread that corresponds to a processor thread of a matrix coprocessor of the processing system, execution-ready operations from the first graph over execution-ready operations from the second graph. In some embodiments, the third shared thread is configured to execute a given execution-ready operation from the second graph if there is no execution-ready operation from the first graph.

In some embodiments, the processing system comprises a neural signal processing (NSP) system.

In certain embodiments, the first graph and the second graph comprise directed acyclic graphs representing operation execution flows related to training or use of the first machine learning model and the second machine learning model.

In some embodiments, the first graph and the second graph are compiled graphs that were generated based on input graphs having fewer operations than the first graph and the second graph. In certain embodiments, the first graph and the second graph were generated by subdividing one or more operations of the input graphs or adding one or more memory movement operations that were not present in the input graphs. For example, the operations related to the first machine learning model in the first graph and the operations related to the second machine learning model in the second graph may include one or more subcomponent operations of one or more operations of one or more input graphs.

Method 500 allows for improved utilization of available processing resources and improved overall execution time for multiple graphs as compared to techniques in which graphs are sequentially executed, such as conventional techniques where one graph is completely executed by a processing system before execution of another graph begins on the processing system.

### Example Processing System for Multi-Graph Execution

In some aspects, the workflows, techniques, and methods described with reference to FIGS. 1-5 may be implemented on one or more devices or systems. FIG. 6 depicts an example processing system 600 configured to perform various aspects of the present disclosure, including, for example, the techniques and methods described with respect to FIGS. 1-5. In some aspects, the processing system 600 may correspond to processing system 120 of FIG. 1. Although depicted as a single system for conceptual clarity, in some aspects, as discussed above, the operations described below with respect to the processing system 600 may be distributed across any number of devices or systems.

The processing system 600 includes a central processing unit (CPU) 602, which in some examples may be a multi-core CPU (e.g., corresponding to processor(s) 120 of FIG. 1). Instructions executed at the CPU 602 may be loaded, for example, from a program memory associated with the CPU 602 or may be loaded from a memory partition (e.g., a partition of memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS), as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes the memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a graph receiving component 624A, a first graph prioritizing component 624B, a second graph prioritizing component 624C, and an operation executing component 624D. Though depicted as discrete components for conceptual clarity in FIG. 6 the illustrated components (and others not depicted) may be collectively or individually implemented in various aspects.

The processing system 600 further comprises a graph receiving circuit 626, a first graph prioritizing circuit 627, a second graph prioritizing circuit 628, and an operation executing circuit 629. The depicted circuits, and others not depicted, may be configured to perform various aspects of the techniques described herein.

For example, the graph receiving component 624A and/or the graph receiving circuit 626 may be used to receive a first graph representing operations related to a first machine learning model and a second graph representing operations related to a second machine learning model, as discussed above with respect to FIGS. 1-5.

The first graph prioritizing component 624B and/or the first graph prioritizing circuit 627 may be used to prioritize, by a first shared thread of processing system 600, execution-ready operations from the first graph over execution-ready operations from the second graph, as described above with respect to FIGS. 1-5.

The second graph prioritizing component 624C and/or the second graph prioritizing circuit 628 may be used to prioritize, by a second shared thread of the processing system 600, execution-ready operations from the second graph over execution-ready operations from the first graph, as described above with respect to FIGS. 1-5.

The operation executing component 624D and/or the operation executing circuit 629 may be used to execute, by the first shared thread and the second shared thread, respective operations related to the first machine learning model and the second machine learning model based on the prioritizing by the first shared thread and the prioritizing by the second shared thread, as described above with respect to FIGS. 1-5.

Though depicted as separate components and circuits for clarity in FIG. 6, the graph receiving circuit 626, the first graph prioritizing circuit 627, the second graph prioritizing circuit 628, and/or the operation executing circuit 629 may collectively or individually be implemented in other processing devices of the processing system 600, such as within the CPU 602, the GPU 604, the DSP 606, the NPU 608, and the like. For example, the association determining circuit 626, the tag generating circuit 627, and the tag associating circuit 628 may be implemented via one or more instructions in an instruction set of the CPU 602, the GPU 604, the DSP 606, the NPU 608, or the like.

Generally, the processing system 600 and/or components thereof may be configured to perform the methods described herein.

Notably, in other aspects, elements of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 may be distributed between multiple devices.

### Example Clauses

Implementation examples are described in the following numbered clauses:

Clause 1: A method for multi-graph scheduling in a processing system, comprising: receiving, by the processing system, a first graph representing operations related to a first machine learning model and a second graph representing operations related to a second machine learning model; prioritizing, by a first shared thread of the processing system, execution-ready operations from the first graph over execution-ready operations from the second graph; prioritizing, by a second shared thread of the processing system, execution-ready operations from the second graph over execution-ready operations from the first graph; and executing, by the first shared thread and the second shared thread, respective operations related to the first machine learning model and the second machine learning model based on the prioritizing by the first shared thread and the prioritizing by the second shared thread.

Clause 2: The method of Clause 1, wherein the first shared thread is configured to execute an execution-ready operation from the second graph if there is no execution-ready operation from the first graph, and wherein the second shared thread is configured to execute an execution-ready operation from the first graph if there is no execution-ready operation from the second graph.

Clause 3: The method of any one of Clause 1-2, wherein the prioritizing by the first shared thread comprises determining whether there is an execution-ready operation from the second graph upon determining that there is no execution-ready operation from the first graph, wherein the first shared thread is configured to wait for a given condition to occur if there is no execution-ready operation from the second graph.

Clause 4: The method of Clause 3, wherein the given condition relates to expiry of a time period or availability of a given execution-ready operation, and wherein, when the given condition occurs, the first shared thread is configured to again prioritize execution-ready operations from the first graph over execution-ready operations from the second graph.

Clause 5: The method of any one of Clause 1-4, further comprising determining, by the first shared thread, whether there is an execution-ready operation from the first graph based on one or more dependencies in the first graph.

Clause 6: The method of any one of Clause 1-5, wherein the first shared thread and the second shared thread correspond to respective processor threads of a vector coprocessor of the processing system.

Clause 7: The method of Clause 6, further comprising prioritizing, by a third shared thread that corresponds to a processor thread of a matrix coprocessor of the processing system, execution-ready operations from the first graph over execution-ready operations from the second graph, wherein the third shared thread is configured to execute a given execution-ready operation from the second graph if there is no execution-ready operation from the first graph.

Clause 8: The method any one of Clause 6-7, wherein the processing system comprises a neural signal processing (NSP) system.

Clause 9: The method of any one of Clause 1-8, wherein the first graph and the second graph comprise directed acyclic graphs representing operation execution flows related to training or use of the first machine learning model and the second machine learning model.

Clause 10: The method of any one of Clause 1-9, wherein the first graph and the second graph are compiled graphs that were generated based on input graphs having fewer operations than the first graph and the second graph.

Clause 11: The method of Clause 10, wherein the first graph and the second graph were generated by subdividing one or more operations of the input graphs or adding one or more memory movement operations that were not present in the input graphs.

Clause 12: A processing system comprising: one or more memories comprising processor-executable instructions; and one or more processors configured to execute the processor-executable instructions and cause the processing system to: receive, by the processing system, a first graph representing operations related to a first machine learning model and a second graph representing operations related to a second machine learning model; prioritize, by a first shared thread of the processing system, execution-ready operations from the first graph over execution-ready operations from the second graph; prioritize, by a second shared thread of the processing system, execution-ready operations from the second graph over execution-ready operations from the first graph; and execute, by the first shared thread and the second shared thread, respective operations related to the first machine learning model and the second machine learning model based on the prioritizing by the first shared thread and the prioritizing by the second shared thread.

Clause 13: The processing system of Clause 12, wherein the first shared thread is configured to execute an execution-ready operation from the second graph if there is no execution-ready operation from the first graph, and wherein the second shared thread is configured to execute an execution-ready operation from the first graph if there is no execution-ready operation from the second graph.

Clause 14: The processing system of any one of Clause 12-13, wherein the prioritizing by the first shared thread comprises determining whether there is an execution-ready operation from the second graph upon determining that there is no execution-ready operation from the first graph, wherein the first shared thread is configured to wait for a given condition to occur if there is no execution-ready operation from the second graph.

Clause 15: The processing system of Clause 14, wherein the given condition relates to expiry of a time period or availability of a given execution-ready operation, and wherein, when the given condition occurs, the first shared thread is configured to again prioritize execution-ready operations from the first graph over execution-ready operations from the second graph.

Clause 16: The processing system of any one of Clause 12-15, wherein the one or more processors are further configured to execute the processor-executable instructions and cause the processing system to determine, by the first shared thread, whether there is an execution-ready operation from the first graph based on one or more dependencies in the first graph.

Clause 17: The processing system of any one of Clause 12-16, wherein the first shared thread and the second shared thread correspond to respective processor threads of a vector coprocessor of the processing system.

Clause 18: The processing system of Clause 17, wherein the one or more processors are further configured to execute the processor-executable instructions and cause the processing system to prioritize, by a third shared thread that corresponds to a processor thread of a matrix coprocessor of the processing system, execution-ready operations from the first graph over execution-ready operations from the second graph, wherein the third shared thread is configured to execute a given execution-ready operation from the second graph if there is no execution-ready operation from the first graph.

Clause 19: The processing system of any one of Clause 17-18, wherein the processing system comprises a neural signal processing (NSP) system.

Clause 20: An apparatus, comprising: means for receiving, by a processing system, a first graph representing operations related to a first machine learning model and a second graph representing operations related to a second machine learning model; means for prioritizing, by a first shared thread of the processing system, execution-ready operations from the first graph over execution-ready operations from the second graph; means for prioritizing, by a second shared thread of the processing system, execution-ready operations from the second graph over execution-ready operations from the first graph; and means for executing, by the first shared thread and the second shared thread, respective operations related to the first machine learning model and the second machine learning model based on the prioritizing by the first shared thread and the prioritizing by the second shared thread.

Clause 21: The apparatus of Clause 20, further comprising means for carrying out the method of any one of Clause 2-11.

Clause 22: A non-transitory computer readable medium comprising instructions that, when executed by one or more processors of a computing system, cause the computing system to perform the method of any one of Clause 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for multi-graph scheduling in a processing system, comprising:
receiving, by the processing system, a first graph representing operations related to a first machine learning model and a second graph representing operations related to a second machine learning model;
prioritizing, by a first shared thread of the processing system, execution-ready operations from the first graph over execution-ready operations from the second graph;
prioritizing, by a second shared thread of the processing system, execution-ready operations from the second graph over execution-ready operations from the first graph; and
executing, by the first shared thread and the second shared thread, respective operations related to the first machine learning model and the second machine learning model based on the prioritizing by the first shared thread and the prioritizing by the second shared thread.

2. The method of claim 1, wherein the first shared thread is configured to execute an execution-ready operation from the second graph if there is no execution-ready operation from the first graph, and wherein the second shared thread is configured to execute an execution-ready operation from the first graph if there is no execution-ready operation from the second graph.

3. The method of claim 1, wherein the prioritizing by the first shared thread comprises determining whether there is an execution-ready operation from the second graph upon determining that there is no execution-ready operation from the first graph, wherein the first shared thread is configured to wait for a given condition to occur if there is no execution-ready operation from the second graph.

4. The method of claim 3, wherein the given condition relates to expiry of a time period or availability of a given execution-ready operation, and wherein, when the given condition occurs, the first shared thread is configured to again prioritize execution-ready operations from the first graph over execution-ready operations from the second graph.

5. The method of claim 1, further comprising determining, by the first shared thread, whether there is an execution-ready operation from the first graph based on one or more dependencies in the first graph.

6. The method of claim 1, wherein the first shared thread and the second shared thread correspond to respective processor threads of a vector coprocessor of the processing system.

7. The method of claim 6, further comprising prioritizing, by a third shared thread that corresponds to a processor thread of a matrix coprocessor of the processing system, execution-ready operations from the first graph over execution-ready operations from the second graph, wherein the third shared thread is configured to execute a given execution-ready operation from the second graph if there is no execution-ready operation from the first graph.

8. The method of claim 6, wherein the processing system comprises a neural signal processing (NSP) system.

9. The method of claim 1, wherein the first graph and the second graph comprise directed acyclic graphs representing operation execution flows related to training or use of the first machine learning model and the second machine learning model.

10. The method of claim 1, wherein the first graph and the second graph are compiled graphs that were generated based on input graphs having fewer operations than the first graph and the second graph.

11. The method of claim 10, wherein the first graph and the second graph were generated by subdividing one or more operations of the input graphs or adding one or more memory movement operations that were not present in the input graphs.

12. A processing system comprising:
one or more memories comprising processor-executable instructions; and
one or more processors configured to execute the processor-executable instructions and cause the processing system to:
receive, by the processing system, a first graph representing operations related to a first machine learning model and a second graph representing operations related to a second machine learning model;
prioritize, by a first shared thread of the processing system, execution-ready operations from the first graph over execution-ready operations from the second graph;
prioritize, by a second shared thread of the processing system, execution-ready operations from the second graph over execution-ready operations from the first graph; and
execute, by the first shared thread and the second shared thread, respective operations related to the first machine learning model and the second machine learning model based on the prioritizing by the first shared thread and the prioritizing by the second shared thread.

13. The processing system of claim 12, wherein the first shared thread is configured to execute an execution-ready operation from the second graph if there is no execution-ready operation from the first graph, and wherein the second shared thread is configured to execute an execution-ready operation from the first graph if there is no execution-ready operation from the second graph.

14. The processing system of claim 12, wherein the prioritizing by the first shared thread comprises determining whether there is an execution-ready operation from the second graph upon determining that there is no execution-ready operation from the first graph, wherein the first shared thread is configured to wait for a given condition to occur if there is no execution-ready operation from the second graph.

15. The processing system of claim 14, wherein the given condition relates to expiry of a time period or availability of a given execution-ready operation, and wherein, when the given condition occurs, the first shared thread is configured to again prioritize execution-ready operations from the first graph over execution-ready operations from the second graph.

16. The processing system of claim 12, wherein the one or more processors are further configured to execute the processor-executable instructions and cause the processing system to determine, by the first shared thread, whether there is an execution-ready operation from the first graph based on one or more dependencies in the first graph.

17. The processing system of claim 12, wherein the first shared thread and the second shared thread correspond to respective processor threads of a vector coprocessor of the processing system.

18. The processing system of claim 17, wherein the one or more processors are further configured to execute the processor-executable instructions and cause the processing system to prioritize, by a third shared thread that corresponds to a processor thread of a matrix coprocessor of the processing system, execution-ready operations from the first graph over execution-ready operations from the second graph, wherein the third shared thread is configured to execute a given execution-ready operation from the second graph if there is no execution-ready operation from the first graph.

19. The processing system of claim 17, wherein the processing system comprises a neural signal processing (NSP) system.

20. An apparatus, comprising:
means for receiving, by a processing system, a first graph representing operations related to a first machine learning model and a second graph representing operations related to a second machine learning model;
means for prioritizing, by a first shared thread of the processing system, execution-ready operations from the first graph over execution-ready operations from the second graph;
means for prioritizing, by a second shared thread of the processing system, execution-ready operations from the second graph over execution-ready operations from the first graph; and
means for executing, by the first shared thread and the second shared thread, respective operations related to the first machine learning model and the second machine learning model based on the prioritizing by the first shared thread and the prioritizing by the second shared thread.
